(19) United States
(12) Patent Application Publication
(10) Pub. No.: US 2026/0274400 A1
(43) Pub. Date: Sep. 17, 2026

(54) ULTRA HIGH TEMPERATURE THRUST FLOW ACTUATOR TO MINIMIZE FRICTION AND LEAKAGE

(71) Applicant: AGENCY FOR DEFENSE DEVELOPMENT, Daejeon (KR)

(72) Inventors: Yeon Gwan LEE, Daejeon (KR); Min Soo JANG, Daejeon (KR)

(73) Assignee: AGENCY FOR DEFENSE DEVELOPMENT, Daejeon (KR)

(21) Appl. No.: 19/022,132

(22) Filed: Jan. 15, 2025

(30) Foreign Application Priority Data
Jan. 24, 2024 (KR) 10-2024-0010989

(51) Int. Cl. B64C 15/14; F16K 3/22; F16K 3/316

(52) U.S. Cl. CPC B64C 15/14; F16K 3/22; F16K 3/3165

(57) ABSTRACT

Provided is an ultra-high temperature thrust flow actuator to minimize friction and leakage, capable of minimizing the friction coefficient between a shutter and a high-pressure chamber, when a jamming occurs by thermal expansion at high temperatures between the rotating body and the housing, in structures like thrust devices used for controlling the attitude of spacecraft, such as satellites, or weapons, such as missiles, in aerospace and flight environments. The ultra-high temperature thrust flow actuator includes: a driving unit configured to open and close a jetting port of a flow jetting unit ejecting high-temperature high-pressure gas, thereby controlling a flow of the high-temperature high-pressure gas; and a plurality of protruding units, each protruding outwardly from the driving unit.

### CROSS-REFERENCE TO RELATED APPLICATION

This application claims priority to Korean Patent Application No. 10-2024-0010989 filed on Jan. 24, 2024, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to an ultra-high temperature thrust flow actuator for minimizing friction and leakage. In particular, the present disclosure relates to an ultra-high temperature thrust flow actuator to reduce friction and leakage, which minimizes friction between a rotating body and a housing in the structures such as thrust devices that control posture, as well as minimizes the loss of high-temperature high-pressure gas within the thrust device.

### 2. Description of the Related Art

In general, a thrust device is a device mounted on an aircraft or weapon to generate thrust for controlling its attitude and direction.

Such thrust is typically generated by combusting propellants or ejecting high-pressure gas.

For example, in aerospace and flight environments, structures such as thrust devices used to control the attitude of spacecraft like satellites or weapons like missiles can generate thrust to control posture by ejecting high-temperature high-pressure gas.

FIG. 1 is a diagram illustrating the structure of a conventional thrust device using a shutter, and FIG. 2 is a diagram showing problems in the structure of the conventional thrust device.

Referring to FIG. 1, the conventional thrust device using the shutter includes a high-pressure chamber 1 containing high-temperature high-pressure gas, a shutter 2 configured to rotate such that the high-temperature high-pressure gas within the high-pressure chamber 1 is released, and a nozzle 3 through which a flow of the high-temperature high-pressure gas is discharged by rotation of the shutter 2.

In other words, the conventional shutter-type thrust device utilizes the structure such as a shutter 2 that opens and closes the high-temperature high-pressure gas.

Such a structure, like the shutter 2, operates by rotational motion around a vertical axis.

Referring to FIG. 2, the rotation of the shutter 2 causes the high-temperature high-pressure gas in the high-pressure chamber 1 to discharge through the nozzle 3. As a result, the conventional shutter-type thrust device generates thrust in the direction opposite to the direction of flow jet of the high-temperature high-pressure gas.

However, in the conventional art, thermal expansion of the shutter 2 at high temperatures creates friction due to jamming between the rotating shutter 2 as the rotating body and the high-pressure chamber 1 as the housing.

That is, the jamming caused by friction could render the shutter 2 inoperable.

To prevent this inoperable status, the gap at the contact points between the shutter 2 and the high-pressure chamber 1 can be increased to reduce jamming. However, increasing the gap at the contact points may lead to leakage of the high-temperature high-pressure gas, resulting in gas loss.

### Related Patent Document

Korean Patent No. 10-1466020

### SUMMARY OF THE DISCLOSURE

The purpose of the present disclosure, which aims to solve the aforementioned conventional problems, is to provide an ultra-high temperature thrust flow actuator to minimize friction and leakage, capable of minimizing the friction coefficient between a rotating body, such as a shutter, and a housing, such as a high-pressure chamber, when a jamming occurs by thermal expansion at high temperatures between the rotating body and the housing, in structures like thrust devices used for controlling the attitude of spacecraft, such as satellites, or weapons, such as missiles, in aerospace and flight environments.

In addition, the purpose of the present disclosure is to provide an ultra-high temperature thrust flow actuator to minimize friction and leakage, by increasing the gap between the shutter and the high-pressure chamber, thereby minimizing flow loss caused by the leakage of high-temperature high-pressure gas from the high-pressure chamber, in the case where the jamming does not occur between the shutter and the high-pressure chamber.

In order to achieve the purpose, an aspect of the present disclosure provides an ultra-high temperature thrust flow actuator to minimize friction and leakage, the actuator comprising: a driving unit configured to open and close a jetting port of a flow jetting unit ejecting high-temperature high-pressure gas, thereby controlling a flow of the high-temperature high-pressure gas; and a plurality of protruding units, each protruding outwardly from the driving unit.

In some exemplary embodiment, each of the plurality of protruding units may be configured to reduce a gap between the flow jetting unit and the driving unit.

In some exemplary embodiments, the gap may be formed in consideration of a high-temperature deformation prediction value and a thermal expansion coefficient of the driving unit.

In some exemplary embodiments, each of the plurality of protruding units may be configured to reduce frictional force when a jamming occurs between the flow jetting unit and the driving unit.

In some exemplary embodiments, the frictional force may be determined by a shape and a thickness of each of the plurality of protruding units.

In some exemplary embodiments, each of the plurality of protruding units may be either one of a slot pin, a low-hardness material structure or a rolling-shaped structure.

In addition, in order to achieve the purpose, another aspect of the present disclosure provides an ultra-high temperature thrust flow actuator to minimize friction and leakage, the actuator comprising: a driving unit configured to open and close a jetting port of a flow jetting unit ejecting high-temperature high-pressure gas, thereby controlling a flow of the high-temperature high-pressure gas; and a plurality of protruding units, each protruding outwardly from the driving unit, wherein each of the plurality of protruding units is a slot pin inserted into the driving unit from an outer side of the driving unit.

In some exemplary embodiments, the slot pin may have deformation absorption flexibility at a high temperature.

In some exemplary embodiments, the slot pin may be designed by using at least one variable selected from a group consisting of a diameter, a thickness and a spread angle depending on an operating condition.

In some exemplary embodiments, the slot pin may be configured to reduce frictional force by adjusting a shape of a hole into which the slot pin embedded in the driving unit.

In some exemplary embodiments, a size of the hole into which the slot pin is embedded is equal to or larger than a size of the slot pin, allowing compression caused by parallel movement of the slot pin.

In addition, in order to achieve the purpose, still another aspect of the present disclosure provides an ultra-high temperature thrust flow actuator to minimize friction and leakage, the actuator comprising: a driving unit configured to open and close a jetting port of a flow jetting unit ejecting high-temperature high-pressure gas, thereby controlling a flow of the high-temperature high-pressure gas; and a plurality of protruding units, each protruding outwardly from the driving unit, wherein each of the plurality of protruding units is a low-hardness material structure in a shape of a cylinder (rod) protruding outwardly from the driving unit.

In some exemplary embodiments, a material of the low-hardness material structure may have hardness lower than a material of a portion in contact with the flow jetting unit.

In some exemplary embodiments, the low-hardness material structure may have deformation absorption flexibility to accommodate scratches when the driving unit is in operation.

In some exemplary embodiments, a material of the low-hardness material structure may include at least one selected from a group consisting of a material exhibiting low hardness at a room temperature and a material exhibiting hardness reduced by being softened at a high temperature.

In some exemplary embodiments, the material of the low-hardness material structure may include at least one selected from a group consisting of silica fiber-reinforced plastic and carbon fiber-reinforced plastic.

In some exemplary embodiments, a cross section of the low-hardness material structure may be polygonal or circular.

Meanwhile, in order to achieve the purpose, still another aspect of the present disclosure provides an ultra-high temperature thrust flow actuator to minimize friction and leakage, the actuator comprising: a driving unit configured to open and close a jetting port of a flow jetting unit ejecting high-temperature high-pressure gas, thereby controlling a flow of the high-temperature high-pressure gas; and a plurality of protruding units, each protruding outwardly from the driving unit, wherein each of the plurality of protruding units is a bearing structure having a rolling structure.

In some exemplary embodiments, the bearing structure may be a needle roller bearing or a ball bearing.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, in structures such as thrust devices used for controlling the attitude of spacecraft, such as satellites, or weapons, such as missiles, in aerospace and flight environments, the actuator according to an exemplary embodiment of the present disclosure has the effect of minimizing the friction coefficient between a rotating body, such as a shutter, and a housing, such as a high-pressure chamber, in the event of jamming caused by thermal expansion at high temperatures.

Furthermore, according to the present disclosure, by increasing the gap between the shutter and the high-pressure chamber, the actuator according to an exemplary embodiment of the present disclosure has the effect of minimizing flow loss caused by the leakage of high-temperature high-pressure gas from the high-pressure chamber in the event of minor jamming or no jamming between the shutter and the high-pressure chamber.

Furthermore, according to the present disclosure, the actuator according to an exemplary embodiment of the present disclosure has the effect of being applicable to structures where operation in high-temperature environments and jamming caused by thermal expansion are anticipated, such as combustion chambers for launch vehicle propulsion requiring combustion flame control, thrust devices, plants, and internal combustion engines.

### BRIEF DESCRIPTION OF THE DRAWINGS

FIG. 1 is a diagram illustrating the structure of a conventional thrust device using a shutter.

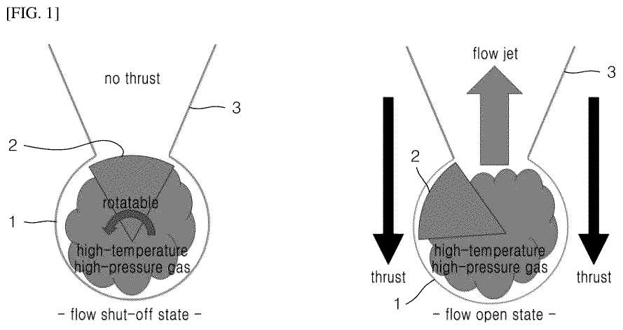

FIG. 2 is a diagram showing problems in the structure of the conventional thrust device.

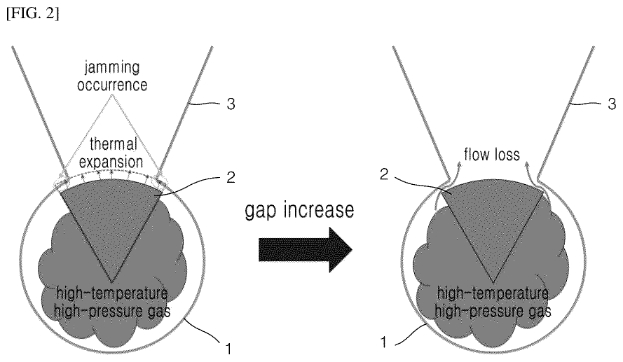

FIG. 3 is a conceptual diagram illustrating a flight vehicle according to an exemplary embodiment of the present disclosure.

FIG. 4 is a conceptual diagram showing a cross section including the thrust device of the flight vehicle shown in FIG. 3.

FIG. 5 is a diagram illustrating the reduction of flow loss and driving friction.

FIG. 6 is a diagram showing exemplary embodiments of applying friction reduction structures.

FIG. 7 is a diagram illustrating a deformation absorption structure using slot pins.

FIG. 8 is a diagram showing design variables for the cross-sectional dimensions of a slot pin.

FIG. 9 is a diagram illustrating the configuration of an anti-rotation stopper.

FIG. 10 is a diagram showing the cross-section and design variables of a slot pin.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

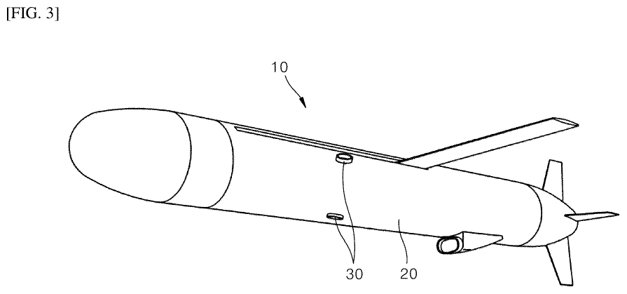

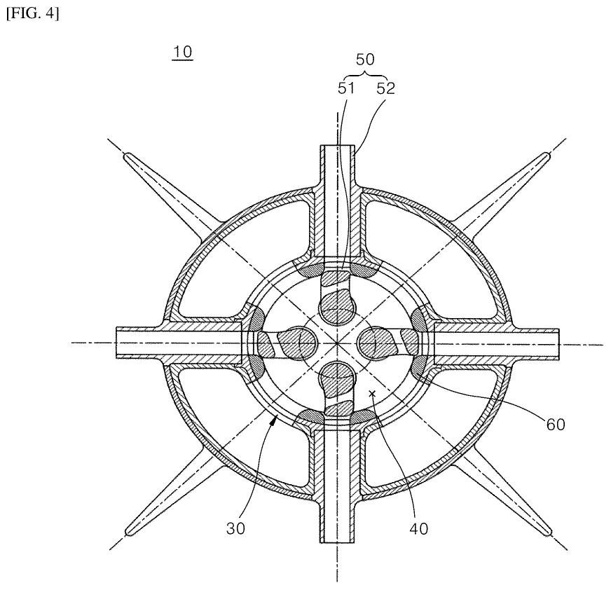

FIG. 3 is a conceptual diagram illustrating a flight vehicle according to an exemplary embodiment of the present disclosure, and FIG. 4 is a conceptual diagram showing a cross section including the thrust device of the flight vehicle shown in FIG. 3.

Referring to FIGS. 3 and 4, a flight vehicle 10 according to the present disclosure may include a flight body 20 and a thrust device 30.

The flight vehicle 10 according to an exemplary embodiment of the present disclosure is a flight vehicle 10 used in aerospace and flight environments, such as spacecraft like satellites or weapons like missiles, for controlling attitude.

The flight body 20 is launched by obtaining thrust at one end through propulsion gunpowder.

The thrust device 30 is provided on the flight body 20.

The thrust device 30 may be arranged near the central part of the flight body 20.

The thrust device 30 is capable of ejecting gas from the inside to the outside of the flight body 20.

Through the ejection of gas as described above, the flight vehicle can perform horizontal movements in the upward, downward, leftward, and rightward directions of its trajectory.

In other words, the thrust device 30 can move the flight vehicle 10 in a direction perpendicular to the propulsion force generated by the propulsion gunpowder.

The thrust device 30 includes a high-pressure chamber 40, a nozzle unit 50, and a shutter unit 60.

The high-pressure chamber 40 is a space that forms an internal area within the flight body 20 to contain high-temperature high-pressure gas.

Gas may be supplied to the high-pressure chamber 40 from a gas source (not shown) such that the high-pressure chamber 40 is maintained in a high-temperature and high-pressure state.

In addition, the gas inside the high-pressure chamber 40 may be ejected through the nozzle unit 50 to the outside of the flight body 20, thereby providing the propulsion necessary for moving the flight body 20.

The nozzle unit 50 forms a passage through which gas exits from the high-pressure chamber 40 to the exterior of the body.

The nozzle unit 50 includes a nozzle pipe 52 and a nozzle throat 51 disposed at the junction between the nozzle pipe 52 and the high-pressure chamber 40.

The diameter of the nozzle throat 51 may be narrower than that of the nozzle pipe 52.

This design ensures that gas exits the high-pressure chamber 40 under high pressure, delivering sufficient propulsion force to the flight body 20.

When multiple nozzle units 50 are provided, they may be arranged at an angle of approximately 90 degrees relative to one another.

In other words, when multiple nozzle units 50 are provided, one of the nozzle units 50 may be arranged at an angle of approximately 90 degrees relative to another adjacent nozzle unit 50.

The shutter unit 60 is formed inside the high-pressure chamber 40.

The shutter unit 60 is positioned to block the jetting port of the nozzle unit 50.

The shutter unit 60 is configured rotatable to open the jetting port of the nozzle unit 50, allowing gas stored in the high-pressure chamber 40 to escape.

The shutter unit 60 is designed to be rotatable and is aligned with the positions of the nozzle units 50.

For example, when four nozzle units 50 are formed in the upward, downward, leftward, and rightward directions, four of the shutter unit 60 may be formed to block all four nozzle units 50.

When multiple shutter units 60 are provided, each of the shutter units 60 can rotate independently based on the intended direction of movement of the flight vehicle 10.

As the shutter unit 60 opens the nozzle unit 50, gas exits the high-pressure chamber 40, moving the flight vehicle 10 according to the forces of action and reaction.

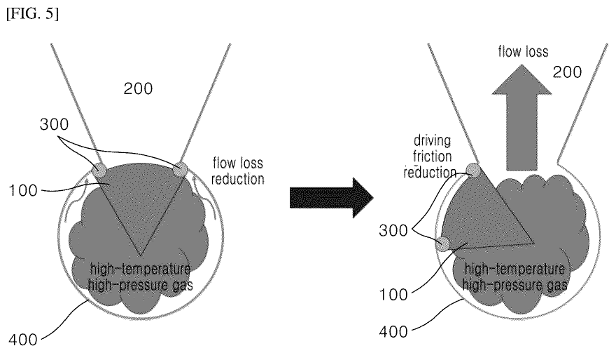

FIG. 5 is a diagram illustrating the reduction of flow loss and driving friction.

Referring to FIG. 5, the ultra-high temperature thrust flow actuator to minimize friction and leakage according to an exemplary embodiment of the present disclosure may include a driving unit 100, a flow jetting unit 200, a protruding unit 300, and a housing unit 400.

Here, the flow jetting unit (200) may eject high-temperature high-pressure gas.

The driving unit 100 may control the flow of the high-temperature high-pressure gas by opening and closing the jetting port of the flow jetting unit 200.

The protruding unit 300 protrudes outwardly from the driving unit 100. The protruding unit 300 may be formed in plurality.

These protruding units 300 may extend toward either the driving unit 100 or the flow jetting unit 200.

While the protruding unit 300 can be assembled to either the driving unit 100 or the housing unit 400, the protruding unit 300 may be preferably assembled to the housing unit 400.

The protruding unit 300 may be configured to narrow the gap between the flow jetting unit 200 and the driving unit 100.

In particular, the protruding structure of the protruding unit 300 may reduce the gap between the driving unit 100 and the flow jetting unit 200, thereby minimizing flow loss of the high-temperature high-pressure gas within the high-pressure chamber.

In addition, in the event of jamming between the protruding unit 300 and the flow jetting unit 200 caused by the thermal expansion of the driving unit 100 at high temperatures, the protruding unit 300 may reduce frictional force between the flow jetting unit 200 and the protruding unit 300 to facilitate the operation of the driving unit 100.

As this friction-reduction mechanism to be implemented, the protruding unit 300 may be either one of a slot pin 310, a low-hardness material structure 320 or a rolling-shaped structure 330.

That is, frictional force between the flow jetting unit 200 and the protruding unit 300 can be reduced using methods such as: employing a slot spring pin (or slot pin 310) structure to allow compression of the protruding unit 300; using a protruding unit 300 made of a low-hardness material that enables the protruding unit 300 to be easily scratched during jamming caused by the operation of the driving unit 100 with the flow jetting unit 200; and utilizing a rolling structure, such as a needle roller bearing, for the protruding unit 300 to reduce frictional force between the flow jetting unit 200 and the protruding unit 300.

Hereinafter, these mechanisms will be described in greater detail.

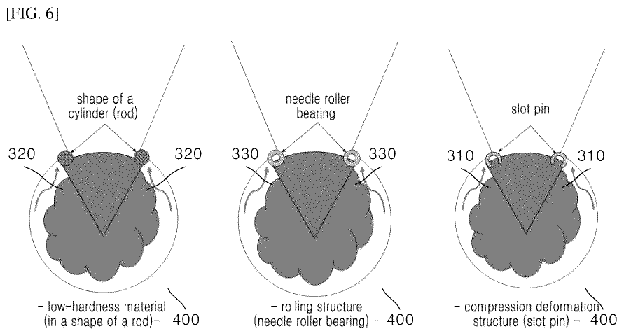

FIG. 6 is a diagram showing exemplary embodiments of applying friction reduction structures.

Referring to FIG. 6, as described above, as the means of reducing frictional force between the flow jetting unit 200 and the protruding unit 300, the protruding unit 300 may be configured as either one of a slot pin 310, a low-hardness material structure 320, or a rolling-shaped structure 330.

In other words, by applying a protruding unit 300 with a friction-reduction structure to the driving unit 100 of the shutter structure, the gap between the flow jetting unit 200 and the protruding unit 300 can be eliminated, thereby reducing frictional force even when compression occurs.

The driving unit 100 of the shutter structure may be an opening and closing mechanism where the shutter rotates to open and close the jetting port of the flow jetting unit 200 such as a nozzle.

Here, a gap-maintaining friction-reduction structure can be applied to the housing unit (400). The gap-maintaining friction-reduction structure may be a slot pin 310, a low-hardness material structure 320 in the shape of a cylinder (rod), or a bearing structure 330 such as a needle roller bearing.

The protruding unit 300, which is a friction-reduction structure, may maintain a narrow gap between the flow jetting unit 200 and the protruding unit 300 during the closing operation of the shutter (i.e., the driving unit 100), thereby preventing flow loss of high-temperature high-pressure gas from the high-pressure chamber.

In addition, when jamming occurs between the driving unit 100 (which serves as the shutter) and the jetting port (such as the nozzle throat) of the flow jetting unit 200 due to thermal expansion of the driving unit 100 at high temperatures, friction between the flow jetting unit 200 and the protruding unit 300 can be reduced through means such as the compression of the slot pin 310, the scratching of low-hardness composite materials, or the rolling action of a needle roller bearing.

To explain in more detail, the ultra-high temperature thrust flow actuator to minimize friction and leakage according to the present disclosure may include, as one example, a driving unit 100, a flow jetting unit 200, and a protruding unit 300. The driving unit 100 may control the flow of high-temperature high-pressure gas by opening and closing the jetting port of the flow jetting unit 200 which ejects gas from the high-pressure chamber.

The protruding unit 300 has a shape protruding outwardly from the driving unit 100 and may be formed in plurality.

More specifically, the protruding unit 300 may be formed at both outer ends of the driving unit 100.

The protruding unit 300 may be a slot pin 310 inserted into the driving unit 100 from an outer side of the driving unit 100.

The slot pin 310 may have a U-shape, i.e., a partially removed donut shape, where both ends of the slot pin 310 may be inserted into the driving unit 100.

The slot pin 310 may be designed based on at least one variable selected from a group consisting of a diameter, a thickness, and a spread angle of both ends, depending on the operating conditions.

In addition, the slot pin 310 may be configured to reduce frictional force by adjusting a shape of a hole into which the slot pin 310 embedded in the driving unit 100.

For example, a size of the hole into which the slot pin 310 is embedded is equal to or larger than a size of the slot pin 310, allowing compression caused by parallel movement of the slot pin 310.

In another example, the ultra-high temperature thrust flow actuator to minimize friction and leakage according to the present disclosure may include a driving unit 100, a flow jetting unit 200, and a protruding unit 300. The driving unit 100 may control the flow of high-temperature high-pressure gas by opening and closing the jetting port of the flow jetting unit 200 that ejects gas from the high-pressure chamber.

The protruding unit 300 has a shape protruding outwardly from the driving unit 100 and may be formed in plurality.

The protruding units 300 may be a low-hardness material structure 320 in a shape of a cylinder (rod) protruding outwardly from the driving unit 100.

In an exemplary embodiment of the present disclosure, a material of the low-hardness material structure 320 may has hardness lower than a material of a portion in contact with the flow jetting unit 200.

In an exemplary embodiment of the present disclosure, a material of the low-hardness material structure 320 may have hardness lower than a hardness of a portion where the flow jetting unit 200 contacts the housing unit 400.

In an exemplary embodiment of the present disclosure, a material of the low-hardness material structure 320 may have hardness lower than a hardness of a portion where the flow jetting unit 200 contacts the driving unit 100.

The low-hardness material structure 320 may have deformation absorption flexibility to accommodate scratches when the driving unit 100 is in operation.

In addition, a material of the low-hardness material structure 320 of the protruding unit 300 may include at least one selected from a group consisting of a material exhibiting low hardness at a room temperature and a material exhibiting hardness reduced by being softened at a high temperature.

For example, the material of the low-hardness material structure 320 may include at least one selected from a group consisting of silica fiber-reinforced plastic and carbon fiber-reinforced plastic.

That is, the low-hardness material structure 320 may be made of composite material such as silica fiber-reinforced plastic and carbon fiber-reinforced plastic.

Meanwhile, according to an exemplary embodiment of the present disclosure, a cross section of the low-hardness material structure 320 may be polygonal or circular.

In other words, the protruding unit 300, which is a low-hardness material structure 320, may be formed in polygonal shapes such as triangular prisms, rectangular prisms, or pentagonal prisms, or in a cylindrical shape. The cross section of the protruding unit 300 may be polygonal, such as a triangle, rectangle, or pentagon, or circular corresponding to the cylindrical shape.

Meanwhile, in still another example, the ultra-high temperature thrust flow actuator to minimize friction and leakage according to the present disclosure may include a driving unit 100, a flow jetting unit 200, and a protruding unit 300. The driving unit 100 may control the flow of high-temperature high-pressure gas by opening and closing the jetting port of the flow jetting unit 200 that ejects gas from the high-pressure chamber.

The protruding unit 300 has a shape protruding outwardly from the driving unit 100 and may be formed in plurality.

The protruding unit 300 may be a bearing structure 330 having a rolling structure.

For example, the protruding unit 300, which is a bearing structure 330, may be a needle roller bearing or a ball bearing. The rolling action of the protruding unit 300, as a bearing structure 330, can reduce friction between the flow jetting unit 200 and the protruding unit 300.

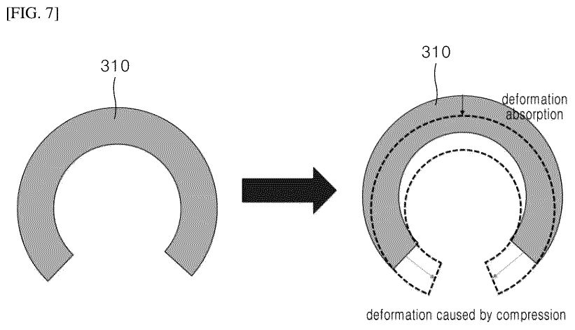

FIG. 7 is a diagram illustrating a deformation absorption structure using slot pins.

Referring to FIG. 7, the slot pin 310 is a structure that allows deformation to the extent of the spread angle of the slot pin 310 when an applied load is exerted.

As a result, when a compressive force is applied due to jamming between the flow jetting unit 200 and the protruding unit 300, the slot pin 310 may deform to the extent of its spread angle, thereby reducing the vertical force acting on the opposing surface corresponding to the deformation.

This reduction in vertical force due to deformation can reduce friction.

In other words, in the ultra-high temperature thrust flow actuator to minimize friction and leakage according to the present disclosure, the protruding unit 300 may reduce frictional force in the event of jamming between the flow jetting unit 200 and the driving unit 100.

In addition, the protruding unit 300 may be located at the driving unit 100 or at the flow jetting unit 200.

In particular, the protruding unit 300 may be positioned at both outer ends of the driving unit 100.

Alternatively, the protruding unit 300 may be positioned at an end of the jetting port of the flow jetting unit 200.

Alternatively, the protruding unit 300 may be positioned at a portion where the flow jetting unit 200 contacts the housing unit 400.

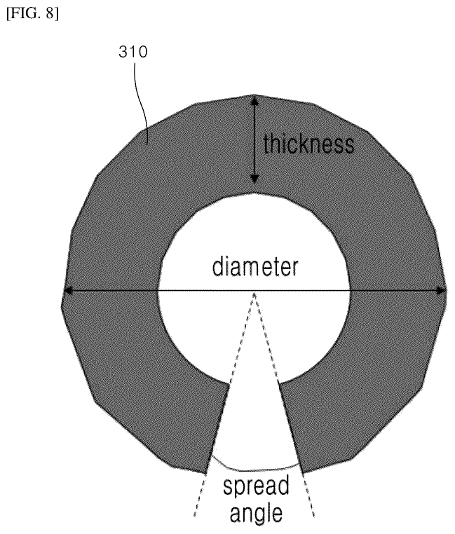

FIG. 8 is a diagram showing design variables for the cross-sectional dimensions of a slot pin.

Referring to FIG. 8, the cross section and design variables of the slot pin 310 can be identified.

The design variables of the slot pin 310 may include a diameter, a thickness, a spread angle, etc.

These design variables affect the stress acting on the slot pin 310, as well as the vertical reaction force and friction acting on the opposing surface.

Therefore, the slot pin 310 may be designed according to the materials and conditions used.

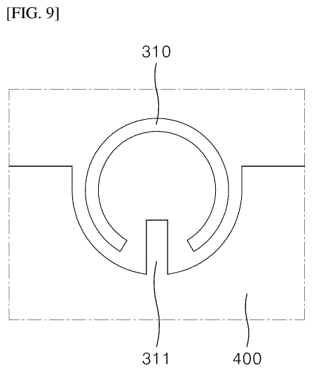

FIG. 9 is a diagram illustrating the configuration of an anti-rotation stopper.

In order to prevent the open section of the slot pin 310 from rotating outward due to rotation of the slot pin 310, the anti-rotation stopper 311 may be applied.

The size of the anti-rotation stopper 311 may preferably be designed to allow a certain degree of rotation of the slot pin 310.

This is to ensure sufficient space to accommodate deformation absorption in the event of jamming between the slot pin 310 and the housing unit 400.

Furthermore, when the anti-rotation stopper 311 is too thick, the anti-rotation stopper may reduce the rotation of the slot pin 310.

Conversely, when the anti-rotation stopper (311) is too thin, the slot pin (310) may lack sufficient strength and could break.

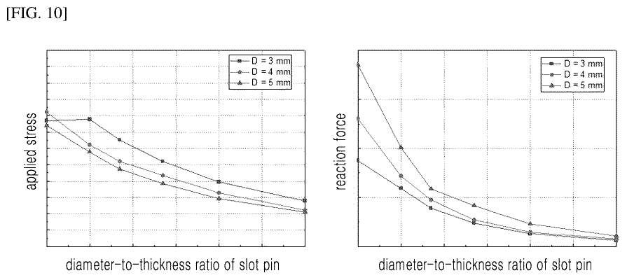

FIG. 10 is a diagram showing the cross-section and design variables of a slot pin.

Referring to FIG. 10, as the diameter-to-thickness ratio of the slot pin 310 increases, the stress and restoring force (vertical force) acting on the slot pin 310 decreases.

Referring to FIG. 7 through FIG. 10, in the ultra-high temperature thrust flow actuator to minimize friction and leakage according to the present disclosure, the gap between the flow jetting unit 200 and the protruding unit 300 may be formed in consideration of a high-temperature deformation prediction value and a thermal expansion coefficient of the driving unit 100.

In addition, the frictional force between the flow jetting unit 200 and the protruding unit 300 may be determined by a shape and a thickness of the protruding unit 300.

Meanwhile, in this exemplary embodiment, the structure in which the protruding unit 300 is mounted at the driving unit 100 has been described for ease of explanation, but the present disclosure is not limited thereto. Thus, the protruding unit 300 may also be mounted at the nozzle throat, i.e., the end of the jetting port, of the flow jetting unit 200.

In other words, in the ultra-high temperature thrust flow actuator to minimize friction and leakage according to the present disclosure, the protruding unit 300 is a structure that maintains the gap between itself and the flow jetting unit 200 while reducing friction during the operation of the driving unit 100.

Such protruding units 300 may include slot pins, low-hardness material structures, or rolling structures.

The gap between the flow jetting unit 200 and the protruding unit 300 may be determined by considering the high-temperature deformation prediction value and the thermal expansion coefficient of the driving unit 100.

In addition, the structure and thickness of the protruding unit 300 may be determined based on the anticipated frictional force that may act in the event of jamming with the flow jetting unit 200.

The protruding unit 300 may be formed at the driving unit 100 or at the flow jetting unit 200.

The slot pin 310, as an example of the protruding unit 300, may utilize deformation absorption flexibility at high temperatures.

Variables such as the diameter, thickness, and spread angle of the slot pin 310 may be designed based on the operating conditions.

Friction can also be reduced by adjusting the shape of the hole where the slot pin 310 is embedded.

For example, the size of the hole may be made larger than the slot pin 310 to allow compression caused by parallel movement rather than deformation of the slot pin 310.

Furthermore, in order to prevent the open section of the slot pin 310 from rotating outward due rotation of the slot pin 310, an anti-rotation stopper 311 may be applied.

The size of the anti-rotation stopper 311 may preferably be designed to allow a certain degree of rotation of the slot pin 310.

This is to ensure sufficient space for deformation absorption in the event of jamming between the slot pin 310 and the housing unit 400.

When the anti-rotation stopper 311 is too thick, the degree of rotation of the slot pin 310 may be reduced. Conversely, when the anti-rotation stopper 311 is too thin, the slot pin 310 may lack sufficient strength and could break.

The low-hardness material structure 320 may utilize materials having hardness lower than the hardness of the contacting portion, enabling deformation absorption flexibility due to scratching during operation.

In addition, the low-hardness material structure 320 may include materials with low hardness at room temperature and/or materials that are softened at high temperatures to result in reduced hardness.

For example, composite materials such as silica fiber-reinforced plastic or carbon fiber-reinforced plastic may be designed to meet the required temperature or stiffness (or strength) specifications.

The cross-section of the low-hardness material structure 320 may be rectangular, circular, or other shapes, depending on the designer's intended purpose.

The rolling structure 330 may employ rolling components such as needle roller bearings or ball bearings.

As described above, according to the present disclosure, in structures such as thrust devices used for controlling the attitude of spacecraft, such as satellites, or weapons, such as missiles, in aerospace and flight environments, the actuator according to an exemplary embodiment of the present disclosure has the effect of minimizing the friction coefficient between a rotating body, such as a shutter, and a housing, such as a high-pressure chamber, in the event of jamming caused by thermal expansion at high temperatures.

Furthermore, according to the present disclosure, by increasing the gap between the shutter and the high-pressure chamber, the actuator according to an exemplary embodiment of the present disclosure has the effect of minimizing flow loss caused by the leakage of high-temperature high-pressure gas from the high-pressure chamber in the event of minor jamming or no jamming between the shutter and the high-pressure chamber.

Furthermore, according to the present disclosure, the actuator according to an exemplary embodiment of the present disclosure has the effect of being applicable to structures where operation in high-temperature environments and jamming caused by thermal expansion are anticipated, such as combustion chambers for launch vehicle propulsion requiring combustion flame control, thrust devices, plants, and internal combustion engines.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: driving unit
200: flow jetting unit
300: protruding unit
310: slot pin
311: anti-rotation stopper
320: low-hardness material structure
330: rolling-shaped structure
400: housing unit

1. An ultra-high temperature thrust flow actuator to minimize friction and leakage, the actuator comprising:
a driving unit configured to open and close a jetting port of a flow jetting unit ejecting high-temperature high-pressure gas, thereby controlling a flow of the high-temperature high-pressure gas; and
a plurality of protruding units, each protruding outwardly from the driving unit,
wherein each of the plurality of protruding units is configured to reduce frictional force when a jamming occurs between the flow jetting unit and the driving unit.

2. The actuator of claim 1,
wherein each of the plurality of protruding units is configured to reduce a gap between the flow jetting unit and the driving unit.

3. The actuator of claim 2,
wherein the gap is formed in consideration of a high-temperature deformation prediction value and a thermal expansion coefficient of the driving unit.

4. (canceled)

5. The actuator of claim 1,
wherein the frictional force is determined by a shape and a thickness of each of the plurality of protruding units.

6. The actuator of claim 1,
wherein each of the plurality of protruding units is either one of a slot pin, a low-hardness material structure or a rolling-shaped structure.

7. An ultra-high temperature thrust flow actuator to minimize friction and leakage, the actuator comprising:
a driving unit configured to open and close a jetting port of a flow jetting unit ejecting high-temperature high-pressure gas, thereby controlling a flow of the high-temperature high-pressure gas; and
a plurality of protruding units, each protruding outwardly from the driving unit,
wherein each of the plurality of protruding units is a slot pin inserted into the driving unit from an outer side of the driving unit.

8. The actuator of claim 7,
wherein the slot pin has deformation absorption flexibility at a high temperature.

9. The actuator of claim 7,
wherein the slot pin is designed by using at least one variable selected from a group consisting of a diameter, a thickness and a spread angle depending on an operating condition.

10. The actuator of claim 7,
wherein the slot pin is configured to reduce frictional force by adjusting a shape of a hole into which the slot pin embedded in the driving unit.

11. The actuator of claim 10,
wherein a size of the hole into which the slot pin is embedded is equal to or larger than a size of the slot pin, allowing compression caused by parallel movement of the slot pin.

12. An ultra-high temperature thrust flow actuator to minimize friction and leakage, the actuator comprising:
a driving unit configured to open and close a jetting port of a flow jetting unit ejecting high-temperature high-pressure gas, thereby controlling a flow of the high-temperature high-pressure gas; and
a plurality of protruding units, each protruding outwardly from the driving unit,
wherein each of the plurality of protruding units is a low-hardness material structure in a shape of a cylinder (rod) protruding outwardly from the driving unit, and
wherein a material of the low-hardness material structure includes at least one selected from a group consisting of a material exhibiting low hardness at a room temperature and a material exhibiting hardness reduced by being softened at a high temperature.

13. The actuator of claim 12,
wherein a material of the low-hardness material structure has hardness lower than a material of a portion in contact with the flow jetting unit.

14. The actuator of claim 13,
wherein the low-hardness material structure has deformation absorption flexibility to accommodate scratches when the driving unit is in operation.

15. (canceled)

16. The actuator of claim 12,
wherein the material of the low-hardness material structure includes at least one selected from a group consisting of silica fiber-reinforced plastic and carbon fiber-reinforced plastic.

17. The actuator of claim 12,
wherein a cross section of the low-hardness material structure is polygonal or circular.

18. An ultra-high temperature thrust flow actuator to minimize friction and leakage, the actuator comprising:
a driving unit configured to open and close a jetting port of a flow jetting unit ejecting high-temperature high-pressure gas, thereby controlling a flow of the high-temperature high-pressure gas; and
a plurality of protruding units, each protruding outwardly from the driving unit,
wherein each of the plurality of protruding units is a bearing structure having a rolling structure.

19. The actuator of claim 18,
wherein the bearing structure is a needle roller bearing or a ball bearing.
